(19) United States
(12) Patent Application Publication
(10) Pub. No.: US 2013/0084036 A1
(43) Pub. Date: Apr. 4, 2013

(54) Optical Waveguide Device and Method of Manufacturing the Same

(71) Applicant: Sumitomo Osaka Cement Co., Ltd., Tokyo (JP)

(72) Inventors: Yuji YAMANE, Tokyo (JP); Mitsuru SAKUMA, Tokyo (JP); Tetsuya FUJINO, Tokyo (JP); Takashi SHINRIKI, Tokyo (JP)

(73) Assignee: Sumitomo Osaka Cement Co., Ltd., Tokyo (JP)

(21) Appl. No.: 13/630,193

(22) Filed: Sep. 28, 2012

(30) Foreign Application Priority Data
Sep. 29, 2011 (JP) 2011-215328

(51) Int. Cl. G02F 1/035; B32B 37/12

(52) U.S. Cl. 385/2; 156/196

(57) ABSTRACT

An optical waveguide device using a thin substrate having an electro-optical effect and having a thickness of 10 μm or less, in which, even when the thin substrate is adhered to a supporting substrate, breakage of the thin substrate or supporting substrate is suppressed, and performance deterioration such as optical loss due to fine cracks is also suppressed. The optical waveguide device includes a thin substrate, which has an electro-optical effect and a thickness of 10 μm or less, and in which an optical waveguide is formed, and a supporting substrate that is adhered to the thin substrate through an adhesion layer. A structure is formed in a thin-substrate side surface of the supporting substrate, and the supporting substrate is annealed at a high temperature that is equal to or lower than the Curie temperature after forming the concavo-convex structure and before being adhered to the thin substrate.

### TECHNICAL FIELD

The present disclosure contains subject matter related to that disclosed in, and priority is claimed to, Japanese Priority Patent Application JP 2011-215328 filed in the Japan Patent Office on Sep. 29, 2011, the entire contents of which are hereby incorporated by reference. The present invention relates to an optical waveguide device and a method of manufacturing the optical waveguide device, and more particularly, to an optical waveguide device in which a thin substrate that has an electro-optical effect and has the thickness of 10 μm or less and a supporting substrate are adhered to each other, and a method of manufacturing the optical waveguide device.

### BACKGROUND ART

In a field of optical measurement or optical communication, optical waveguide devices such as an optical modulator that is made of a substrate having an electro-optical effect are widely used. In addition, so as to realize a wider bandwidth of frequency response characteristics or so as to reduce a drive voltage, the substrate is made to have a small thickness of approximately 10 μm, whereby an effective refractive index of a microwave as a modulation signal is lowered, speed matching between the microwave and an optical wave is contrived, and an improvement in electric field efficiency is contrived. As shown in PTL 1, this thin substrate is used after being adhered to another supporting substrate to have mechanical strength.

In addition, in a structure in which the thin substrate and the supporting substrate are adhered through an adhesion layer, stray light propagating through the adhesion layer is incident again to the thin substrate that is a main substrate, and becomes a factor that causes characteristic deterioration of the optical waveguide device. PTL 2 proposes forming of a concavo-convex structure on an adhesion surface of the supporting substrate to suppress this problem and to increase adhesion strength between the thin substrate and the supporting substrate.

According to PTL 2, it is necessary to form the concavo-convex structure with a size of 1/10 times or more a wavelength of the stray light in the adhesion surface of the supporting substrate so as to suppress re-incidence of the stray light, which propagates through the adhesion layer, into the thin substrate. However, the supporting substrate in which the concavo-convex structure is formed, warpage of a wafer due to processing strain occurs. In a case where warpage of the supporting substrate is large, it is difficult to make the supporting substrate adhere to the thin substrate that is processed to be thin as approximately 10 μm. Even though the adhesion may be performed, since a large stress is applied to the thin substrate, there is a high possibility that the thin substrate that is a main substrate may be broken in a subsequent process. Particularly, in a case of using a supporting substrate, which has a large thermal expansion coefficient, such as lithium niobate (LN), large stress is applied to the thin substrate due to a variation in temperature during a manufacturing process or an operation, productivity significantly decreases.

When forming the concavo-convex structure in the supporting substrate, in the case of using sand blasting, fine cracks occur, and thus there is high risk that the supporting substrate is cracked in a subsequent process. Particularly, in a case where a crystal such as LN that has cleavage is used for the supporting substrate, a wafer is easily broken with common handling.

As described above, in the optical waveguide device which is made of a thin substrate as a main substrate and in which a concavo-convex structure is formed in a supporting substrate, reliability as an optical waveguide device decreases due to breakage during a manufacturing process or an operation, optical loss, and deterioration in performance that are caused due to warpage or fine cracks of the supporting substrate.

### CITATION LIST

[PTL 1] Japanese Unexamined Patent Application Publication No. 2010-85789

[PTL 2] Japanese Unexamined Patent Application Publication No. 2007-264548

### SUMMARY OF INVENTION

### Technical Problem

The invention is made to solve the above-described problems and an object thereof is to provide an optical waveguide device which is made of a thin substrate having an electro-optical effect and having a thickness of 10 μm or less, and in which even when the thin substrate is adhered to a supporting substrate, breakage of the thin substrate or supporting substrate is suppressed, and performance deterioration such as optical loss due to fine cracks is also suppressed.

### Solution to Problem

To solve the above-described problems, according to a first aspect of the invention, there is provided an optical waveguide device including: a thin substrate which has an electro-optical effect and a thickness of 10 μm or less, and in which an optical waveguide is formed; and a supporting substrate that is adhered to the thin substrate through an adhesion layer. A concavo-convex structure is formed in a thin-substrate side surface of the supporting substrate, and the supporting substrate is annealed at a high temperature that is equal to or lower than the Curie temperature after forming the concavo-convex structure and before being adhered to the thin substrate.

According to a second aspect of the invention, in the optical waveguide device according to the first aspect, a size of warpage of the supporting substrate that is adhered to the thin substrate may be at most a half or less of the thickness of the adhesion layer.

According to a third aspect of the invention, in the optical waveguide device according to the first aspect or the second aspect, an electric charge dispersion layer may be formed on the thin-substrate side surface of the supporting substrate.

According to a fourth aspect of the invention, there is provided a method of manufacturing an optical waveguide device that includes a thin substrate which has an electro-optical effect and a thickness of 10 μm or less, and in which an optical waveguide is formed, and a supporting substrate that is adhered to the thin substrate. The method includes: forming a concavo-convex structure in a thin-substrate side surface of the supporting substrate and then the supporting substrate being annealed at a high temperature that is equal to or lower than the Curie temperature; and adhering the supporting substrate to the thin substrate.

### Advantageous Effects of Invention

According to the first aspect of the invention, in the optical waveguide device including: a thin substrate which has an electro-optical effect and a thickness of 10 μm or less, and in which an optical waveguide is formed; and a supporting substrate that is adhered to the thin substrate through an adhesion layer, a concavo-convex structure is formed in a thin-substrate side surface of the supporting substrate, and the supporting substrate is annealed at a high temperature that is equal to or lower than the Curie temperature after forming the concavo-convex structure and before being adhered to the thin substrate. Therefore, processing strain that remains when the concavo-convex structure is formed in the supporting substrate may be removed, and thus warpage of the supporting substrate may be suppressed. As a result, breakage of the thin substrate or the supporting substrate during a manufacturing process or use may be reduced.

Particularly, in a case of using a ferroelectric material such as LN as a supporting substrate, when the supporting substrate is annealed at a high temperature that is equal to or less than the Curie temperature (approximately 1200° C.), fine cracks that occurs by sand blasting may also be annealed, and thus the annealing also contributes to such things as reduction in optical loss of the optical waveguide device.

According to the second aspect of the invention, since the size of warpage of the supporting substrate that is adhered to the thin substrate is at most a half or less of the thickness of the adhesion layer, even when the thin substrate, having the thickness of 10 μm or less, as a main substrate is adhered to the supporting substrate, breakage of the thin substrate due to the warpage of the supporting substrate is suppressed.

According to the third aspect of the invention, since the electric charge dispersion layer is formed on the thin-substrate side surface of the supporting substrate, even when the supporting substrate such as a dielectric material that has a tendency to be electrified is adhered to the thin substrate with an adhesive, an electric field concentration caused by the charging may be suppressed due to the electric charge dispersion layer.

According to the fourth aspect of the invention, in the method of manufacturing an optical waveguide device that includes a thin substrate which has an electro-optical effect and a thickness of 10 μm or less, and in which an optical waveguide is formed, and a supporting substrate that is adhered to the thin substrate, after forming a concavo-convex structure in a thin-substrate side surface of the supporting substrate, the supporting substrate is annealed at a high temperature that is equal to or lower than the Curie temperature, and then the supporting substrate is adhered to the thin substrate. Therefore, the processing strain, which remains when the concavo-convex structure is formed in the supporting substrate, may be removed and thus breakage of the thin substrate or the supporting substrate may be suppressed. In addition, the fine cracks may be annealed, and thus performance deterioration such as optical loss in the optical waveguide device may be suppressed.

### BRIEF DESCRIPTION OF DRAWINGS

FIG. 1 is a view illustrating a state in which a thin substrate as a main substrate and a supporting substrate are adhered to each other to form an optical waveguide device.

FIG. 2 is a view illustrating a state in which an electric charge dispersion layer is formed on a surface of the supporting substrate in the optical waveguide device of the invention.

### DESCRIPTION OF EMBODIMENTS

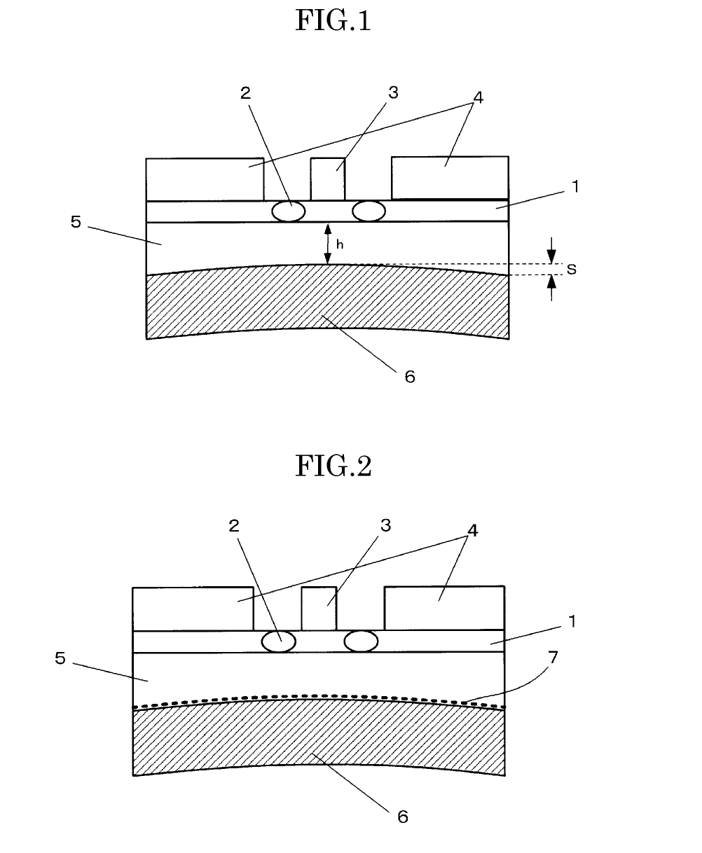

Hereinafter, an optical waveguide device of the invention will be described in detail with reference to an appropriate example. As shown in FIG. 1, the optical waveguide device of the invention includes a thin substrate 1 which has an electro-optical effect and a thickness of 10 μm or less, and in which an optical waveguide 2 is formed, and a supporting substrate 6 that is adhered to the thin substrate 1 through an adhesion layer 5. A concavo-convex structure (not shown) is formed in the thin-substrate side surface of the supporting substrate 6, and the supporting substrate is annealed at a high temperature that is equal to or lower than the Curie temperature after forming the concavo-convex structure and before being adhered to the thin substrate.

In FIG. 1, a reference numeral 3 indicates a signal electrode, and a reference numeral 4 indicates a ground electrode, respectively. A reference numeral h indicates a thickness of the adhesion layer, and a reference numeral S indicates an amount of warpage of the supporting substrate 6.

As the substrate (thin substrate) having an electro-optical effect, particularly, any one of single crystals such as LiNbO₃, LiTaO₅, and PLZT (lead lanthanum zircornate titanate) may be appropriately used. Particularly, LiNbO₃ or LiTaO₅, which have been widely used in an optical modulator, is preferable. In addition, for example, an optical waveguide, which is formed in the substrate, is formed by thermally diffusing a material such as titanium (Ti) having a high refractive index on a LiNbO₃ substrate (LN substrate).

A modulation electrode that modulates an optical wave propagating through the optical waveguide may be provided to the optical waveguide device. The modulation electrode is configured by the signal electrode 3 or the ground electrode 4, and may be formed by a method in which a TI-Au electrode pattern is formed on a substrate surface and gold plating is performed, or the like. Furthermore, a buffer layer such as dielectric SiO₂ may be provided on a substrate surface after forming the optical waveguide, according to necessity.

An ultraviolet ray curable adhesive or the like may be used as an adhesive that adheres the thin substrate 1 and the supporting substrate 6 to each other. However, the thickness h of the adhesion layer 5 is preferably 20 to 200 μm. When the thickness is smaller than 20 μm, it becomes difficult to accomplish speed matching between a microwave as a modulation signal and an optical wave that propagates through the optical waveguide. In addition, when the thickness of the adhesion layer is larger than 200 μm, an internal stress due to expansion and contraction of the adhesion layer itself increases, and thus this becomes a factor that causes breakage of the thin substrate.

As a material of the supporting substrate, the same material as the thin substrate is preferable from a viewpoint of matching a thermal expansion coefficient between the thin substrate and the supporting substrate.

On a thin-substrate side surface (an upper side surface in FIG. 1) of the supporting substrate 6, a concavo-convex structure with a size (approximately 0.1 to 0.2 μm) of 1/10 times or more a wavelength of the stray light, for example, by sand blasting or the like is formed. Due to impacts during the sand blasting, processing strain ranges from a surface of the supporting substrate to a depth of several μm, and due to this, large warpage as shown in FIG. 1 occurs in the supporting substrate 6.

The warpage of the supporting substrate depends on a material that is used. However, even in a supporting substrate that uses LN, in a case of a low-grade material, the warpage of 100 μm or more may occur. In this way, in a case where the warpage of the supporting substrate is large, when the supporting substrate is adhered to the thin substrate having the thickness of 10 μm or less, the thin substrate is easily broken.

Wet etching is known as a method of removing the processing strain of the supporting substrate. However, so as to sufficiently remove the processing strain ranging from a surface of the substrate to a depth of several μm, it is difficult to maintain the concavo-convex structure with a size (approximately 0.1 to 0.2 μm) of 1/10 times or more a wavelength of the stray light.

In the optical waveguide device of the invention, the processing strain of the supporting substrate is removed by annealing. Due to this, the warpage of the supporting substrate may be reduced while maintaining the concavo-convex structure in a surface of the supporting substrate. Particularly, in a case of using the ferroelectric material such as LN for a supporting substrate, it is possible to anneal at a temperature of 400° C. or more and equal to or less than the Curie temperature (in a case of LN, approximately 1140° C.), and this is effective for annealing of fine cracks that occur due to sand blasting or the like.

In the invention, after forming the concavo-convex structure on the thin-substrate side surface of the supporting substrate, the supporting substrate is annealed at a high temperature that is equal to or lower than the Curie temperature, and then the supporting substrate is adhered to the thin substrate. Due to this, the processing strain, which remains when the concavo-convex structure is formed in the supporting substrate, may be surely removed and thus breakage of the thin substrate or the supporting substrate may be suppressed. In addition, the fine cracks may be annealed, and thus performance deterioration such as optical loss in the optical waveguide device may be suppressed.

The magnitude of stress that is applied to the thin substrate due to the warpage of the supporting substrate is also affected by the thickness of the adhesion layer interposed between the supporting substrate and the thin substrate. As shown in FIG. 1, when the value of warpage s of the supporting substrate that is adhered to the thin substrate is at most a half or less of the thickness h of the adhesion layer, it is possible to reduce the application of the stress, which occurs due to the warpage of the supporting substrate, to the thin substrate. For example, in a case where the thickness h of the adhesion layer is approximately 55 μm, the warpage s of the supporting substrate is preferably set to 27.5 μm or less.

A dielectric material, particularly, a ferroelectric material is used for the supporting substrate 6, due to processing strain inside the supporting substrate, a change in internal stress accompanying a change in temperature, an effect of an electric field due to a modulation electrode, or the like, there is a tendency for a pyroelectric effect to occur. So as to suppress this, an electric charge dispersion layer 7 is formed on a thin-substrate side surface of the supporting substrate 6. According to this configuration, even when the supporting substrate, which is formed from a dielectric material or the like having a tendency to be electrically charged, is adhered to the thin substrate with an adhesive, it is possible to suppress an electric field concentration caused by the charging due to the electric charge dispersion layer.

When a material, which has a value of conductivity at least higher than that value of supporting substrate, is used as the electric charge dispersion layer 7, the pyroelectric effect may be mitigated. For example, a semiconductor such as Si or SiN film, or a conductive material may be used.

### INDUSTRIAL APPLICABILITY

As described above, according to the invention, it is possible to provide an optical waveguide device which uses a thin substrate having an electro-optical effect and having the thickness of 10 μm or less, and in which even when the thin substrate is adhered to a supporting substrate, breakage of the thin substrate or supporting substrate is suppressed, and performance deterioration such as optical loss due to fine cracks is also suppressed.

### REFERENCE SIGNS LIST

1: Thin substrate

2: Optical waveguide

3: Signal electrode

4: Ground electrode

5: Adhesion layer

6: Supporting substrate

7: Electric charge dispersion layer

1. An optical waveguide device, comprising:
a thin substrate which has an electro-optical effect and a thickness of 10 μm or less, and in which an optical waveguide is formed; and
a supporting substrate that is adhered to the thin substrate through an adhesion layer,
wherein a concavo-convex structure is formed in a thin-substrate side surface of the supporting substrate, and
the supporting substrate is annealed at a temperature that is equal to or lower than the Curie temperature after forming the concavo-convex structure and before being adhered to the thin substrate.

2. The optical waveguide device according to claim 1,
wherein a size of warpage of the supporting substrate that is adhered to the thin substrate is at most a half or less of the thickness of the adhesion layer.

3. The optical waveguide device according to claim 1,
wherein an electric charge dispersion layer is formed on the thin-substrate side surface of the supporting substrate.

4. The optical waveguide device according to claim 2,
wherein an electric charge dispersion layer is formed on the thin-substrate side surface of the supporting substrate.

5. A method of manufacturing an optical waveguide device that includes a thin substrate which has an electro-optical effect and a thickness of 10 μm or less, and in which an optical waveguide is formed, and a supporting substrate that is adhered to the thin substrate, the method comprising:
forming a concavo-convex structure in a thin-substrate side surface of the supporting substrate, and then annealing the supporting substrate at a high temperature that is equal to or lower than the Curie temperature; and
adhering the supporting substrate to the thin substrate.
